(19) United States
(12) Patent Application Publication
(10) Pub. No.: US 2003/0060180 A1
(43) Pub. Date: Mar. 27, 2003

(54) Image reject receiver

(76) Inventors: William E. Hall, Clarksburg, MD (US); Ico Koullias, Clarksburg, MD (US)

Correspondence Address: J.C. Patents, Inc., 4 Venture, Suite 250, Irvine, CA, 92618, US

(21) Appl. No.: 09/967,708

(22) Filed: Sep. 27, 2001

(51) Int. Cl. H04B 1/10

(52) U.S. Cl. 455/302; 455/303

(57) ABSTRACT

An image reject receiver is provided. The image reject receiver includes a first type low-intermediate frequency receiver, a zero-intermediate frequency receiver and a second low-intermediate frequency receiver. The first type low-intermediate frequency receiver is used for receiving image signal and transferring the image signal into a mirrored image signal with a frequency used in the first low-intermediate frequency receiver. The mirrored image signal is sent to the zero-intermediate frequency receiver and is suppressed to a zero frequency. The signal with the zero frequency is outputted to the second low-intermediate frequency receiver and is then transferred to be with the second intermediate frequency for easily demodulating in the following operation.

### BACKGROUND OF THE INVENTION

1. Field of the Invention

The present invention relates to an image reject receiver. More particularly, the present invention relates to an image reject receiver using multi-low-intermediate frequency receivers and a zero-intermediate frequency conversion receiver for mirrored image signal demodulating.

2. Description of the invention

There are two architectures of the image reject receiver; single-intermediate frequency receiver and multi-intermediate frequency receiver, both have been used for years. Under these architectures, each intermediate frequency stage has to use lot of expensive filters for image signal suppressing. However, it has to lower down the ratio on the received radio frequency (RF) over the intermediate frequency to keep the Q value of the filter on the intermediate frequency within an ideal value. On behalf of making the received image signals to be easily demodulated as well as keeping the Q value of the filter in the intermediate frequency within an ideal value while facing with the condition of higher and higher radio frequency in use nowadays, it will be necessary to apply more and more intermediate frequency stages and the number of the needed intermediate frequency filters will be increased as well.

Accordingly, the technique adopts the architectures of zero-intermediate frequency receiver for solving the problems made by the architectures of single-intermediate frequency receiver and multi-low-intermediate frequency receiver. However, the zero-intermediate frequency receiver for demodulating has to use many expensive analog digital converters and also encountering many problems such as the weak parasite DC signals generated by the disharmony fit of impedance match, self-mixing of local oscillators and the re-radiation, the cross talk of radio frequency by hampering the expected signals.

In addition, the zero-intermediate frequency receiver may also generate weak and trivial base band signals, which are hard to be handled when the changing states of base band signals are increasing. Therefore, to get the process results of precise applications, the analog digital analog converters have to feature the special linear low-noise amplifiers, mixers, excellent independent signals generated by local oscillators (LO) and methods for deleting micro volt DC offsets, however, too many limitations make problems hard to be solved simultaneously.

As described in the above, the technique has many problems, list as following:

1. The higher the operating radio frequency, the more the utilization of intermediate frequency stages, the more the number of filtering devices for intermediate frequency under the architectures of single intermediate frequency receivers and multi-low-intermediate frequency receivers.

2. For the reason of demodulating, the zero-intermediate frequency receiver will need to use many expensive analog digital converters and also will be encountered with problems such like the DC signals made by the disharmony of impedance match, self-mixing of local oscillators and re-radiation and also the cross talk caused by the hampering on radio frequency; and

3. The analog digital converters inside the zero-intermediate frequency receiver must feature special linear low-noise amplifiers, mixers, excellent independent signals generated by local oscillators, methods for deleting micro volt DC offsets, however, so many limitations make the problems hard to be solved simultaneously.

### SUMMARY OF THE INVENTION

Accordingly, the present invention breeches out an image reject receiver utilizing multi-low-intermediate frequency and zero-intermediate frequency receiver. The image reject receiver according to the present invention comprises of a first type intermediate frequency receiver, a zero-intermediate frequency conversion receiver and a second type intermediate frequency receiver. The first type low-intermediate frequency receiver is used as receiving the image signals and using the first intermediate frequency as the signal carriers in the first low-intermediate frequency receiver to become the mirrored image signals, and then, the mirrored image signals will be sent over to the zero-intermediate frequency conversion receiver; after receiving the mirrored image signals, suppress the mirrored image signals on the first intermediate frequency to zero frequency and the second type low-intermediate frequency receiver receives the mirrored image signals suppressed by the zero-intermediate frequency conversion receiver and takes the second type intermediate frequency as carriers used in the second low-intermediate frequency receiver for easy demodulating on the suppressed mirrored image signals.

In addition, the present invention can also use an AC-to-DC calibration circuit to delete the DC offsets generated by zero-intermediate frequency conversion receiver where the DC calibration circuit is located inside the zero-intermediate frequency conversion receiver. From above description, the present invention has been linked in an order with the first type low-intermediate frequency receiver, zero-intermediate frequency receiver and the second type low-intermediate frequency receiver. First of all, just put the image signals as low frequency on the intermediate frequency (the first type low frequency) in the zero-intermediate frequency conversion receiver; however, the job of image signal suppressing will be processed by the zero-intermediate frequency conversion receiver and send the suppressed image signals through the second type low-intermediate frequency receiver to promote the carriers to a certain frequency (second type intermediate frequency) for easy demodulating on the image signals.

For the reason of being better understood in the above description, objects, features and advantages of the present invention, a preferred embodiment will be provided in the following text and accompanying drawings will have a detailed description as well:

### BRIEF DESCRIPTION OF THE DRAWINGS

FIG. 1 shows the block diagram of the interior linking system of image reject receiver according to a preferred embodiment in the present invention; and

FIG. 2 shows the circuit drawing according to another preferred embodiment in the present invention.

### PREFERRED EMBODIMENTS

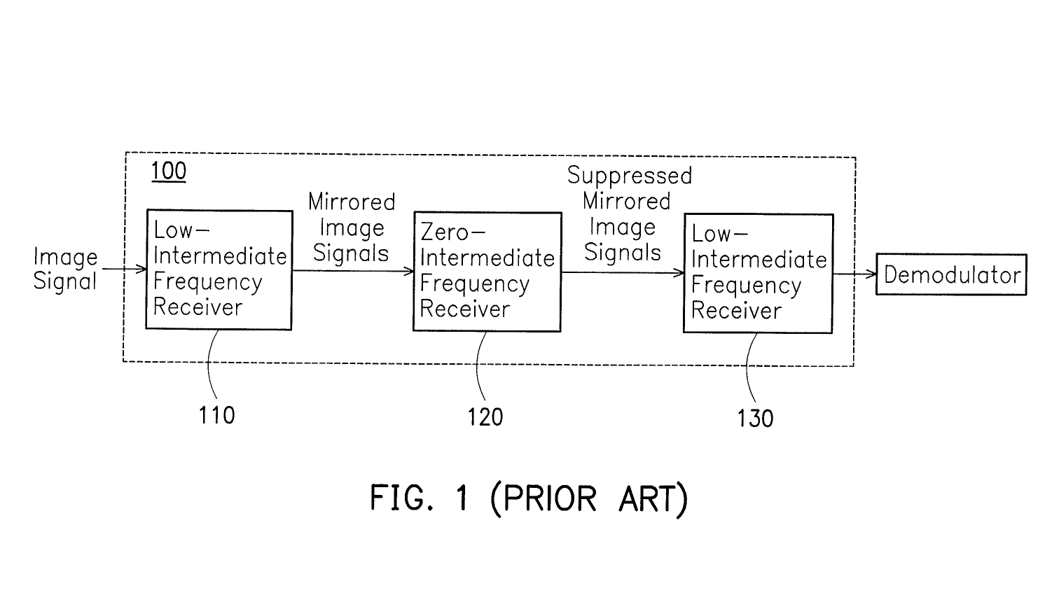

Refer to FIG. 1, which shows block diagrams of an image reject receiver of a preferred embodiment according to the invention. The image reject receiver 100 includes three intermediate frequency (I.F.) receivers, including two low-intermediate frequency receivers 110 and 130 and a zero-intermediate frequency conversion receiver 120.

The low-intermediate frequency receiver 110 (or so-called a first low-intermediate frequency receiver) uses a low-intermediate frequency (or so-called a first low-intermediate frequency) as a carrier for operation. The low-intermediate frequency receiver 110 is used as a first I.F. stage for the image reject receiver 100. The low-intermediate frequency receiver 110 receives an image signal from external source and then transfers the image signal into a mirrored image signal by using the first intermediate frequency as the carrier. The mirrored image signal is placed at the first intermediate frequency.

After the image signal has been transferred into the mirrored image signals at the first intermediate frequency, a zero-intermediate frequency (zero-I.F.) receiver 120 receives the mirrored image signal and downconverts the mirrored image signal down to a zero frequency. The zero-intermediate frequency receiver 110 is used as a second I.F. stage for the image reject receiver 100. The zero-intermediate frequency receiver 120 is chosen to be zero in order to place the mirrored image signal frequency on top of the desired signal while being downconverted in-phase and in-quadrature in order for it to be suppressed. High quality RF or I.F. filters are not reqired for the mirrored image signal suppression. The mirrored image signal suppression is not as severe as in a typical multi-I.F. stage superheterodyne receiver with the use of the zero-I.F. receiver 120. In addition, since the local oscillator (LO) signal can not easily travel through the first I.F. stage to be re-radiated in the attenna or through the upconverted third I.F. stage to be the baseband section, extremely well isolated local oscillator signals are not required as in the typical direct conversion architectures.

The low-intermediate frequency receiver 130 (or so-called a second low-intermediate frequency receiver) will use another low-intermediate frequency (or so-called a second low-intermediate frequency) as a carrier for an operating frequency and receive the suppressed mirrored image signal after the mirrored image signals being suppressed to zero frequency. The low-intermediate frequency receiver 130 is used as a third I.F. stage for the image reject receiver 100. The suppressed mirrored image signal is then upconvertered for the second intermediate frequency in order to permit following simple demodulation. To be followed is that the mirrored image signal with the second intermediate frequency is demodulated.

The second low-intermediate frequency is used as the baseband in order to permit simple demodulation, by which the need for a large and expensive analog to digital converters is eliminated and the zero-I.F. stage LO signals are kept from going into the demodulator. The upconverted frequency of the third I.F. stage determines the center frequency at which the FM demodulator can occur. This frequency can be chosen in order optimize the design for the demodulation which is critical while separating the carrier from the desired modulation signal.

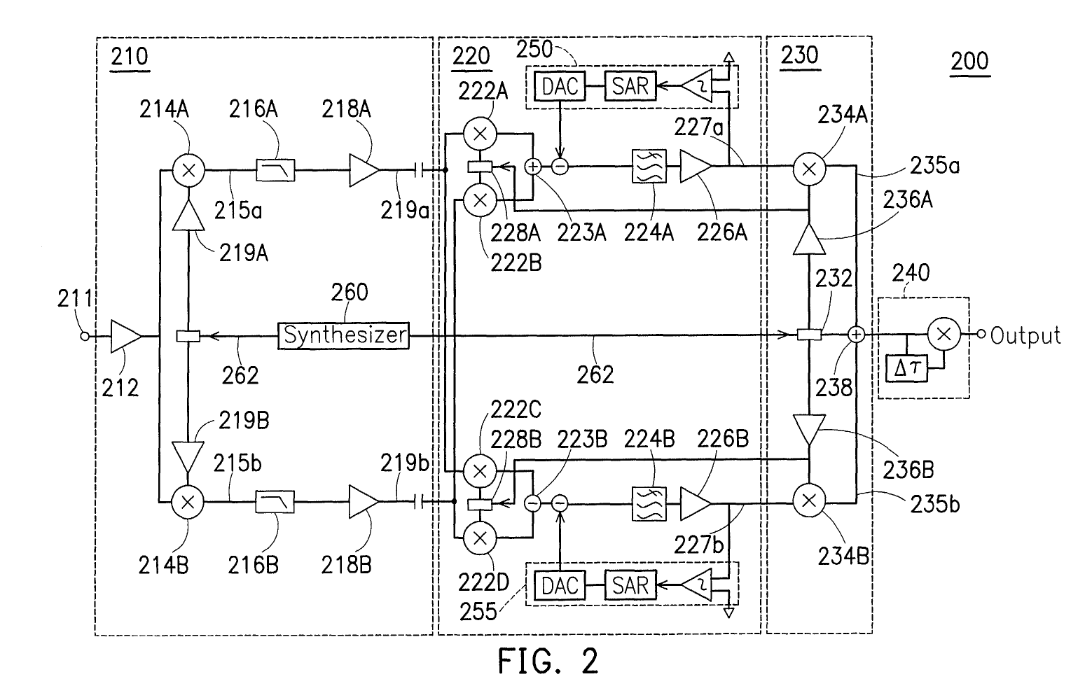

Refer to FIG. 2, which shows a practical circuit of a preferred embodiment according to the present invention. The image reject receiver 200 includes low-intermediate frequency receivers 210 and 230, a zero-intermediate frequency conversion receiver 220 and a demodulator 240. In addition, the zero-intermediate frequency conversion receiver 220 includes DC calibration circuits 250 and 255.

In beginning, an image signal 211 is inputted into a low-intermediate frequency receivers 210 of image reject receiver 200. The low-intermediate frequency receiver 210 is a first I.F. stage for the image reject receiver 200. When an image signal 211 is transferred into the low-intermediate frequency receiver 210 (a first I.F. receiver), it will go through a linear low-noise amplifier (LNA) 212 for making the image signal 211 being amplified without interference by surrounding circumstance. By using mixers 214A and 214B, as shown in FIG. 2, the amplified image signal 211 is then integrated by an intermediate frequency (the first intermediate frequency) being used by the low-intermediate frequency receiver 210. The first intermediate frequency is produced by a frequency of a local oscillating signal 262 generated by synthesizers 260.

The integrated image signals 215a and 215b then respectively goes through low pass filters 216A and 216B, and amplifiers 218A and 218B. After that, the integrated image signals 215a and 215b with a high frequency are respectively transferred to be mirrored image signals 219a and 219b using the first intermediate frequency as a carrier. During the processing of transferring a signal with a high frequency to be with a low frequency, the local oscillating signal 262 and the integrated image signals 215a and 215b are different from each other. Therefore, a chance of re-radiation caused by the local oscillating signal being entered into the antenna is reduced. The chance of re-radiation into the antenna is a disadvantage of simply using a zero-intermediate frequency conversion receiver in the conventional architecture. Therefore, the re-radiation reduction of the architecture of the invention is better than the conventional architecture.

The mirrored image signals 219a and 219b generated by the low-intermediate frequency receiver 210 are inputted into a zero-intermediate frequency receiver 220. The zero-intermediate frequency receiver 220 is a second I.F. stage for the image reject receiver 200. The mirrored image signals 219a and 219b are mixed with the local oscillating signal 262 after respectively going through the mixers 222A, 222B, 222C and 222D, as shown in FIG. 2. A suppressed mirrored image signal 227a is generated after the mirrored image signals 219a and 219b being passing through an adder 223A, a low pass filter 224A and an amplifier 226A. Another suppressed mirrored image signal 227b is generated after the mirrored image signals 219a and 219b being passing through an adder 223B, a low pass filter 224B and an amplifier 226B. DC calibration circuits 250 and 255 are used to eliminate microvolt DC offsets generated accompanying with results of the suppressed mirrored image signals 227a and 227b.

The suppressed mirrored image signals 227a and 227b are passed through the low-intermediate frequency receiver 230. The low-intermediate frequency receiver 230 is a third I.F. stage for the image reject receiver 200. The suppressed mirrored image signals 227a and 227b are respectively passed through mixers 234A and 234B to being mixed with an intermediate frequency, and the mixed suppressed mirrored image signals 235a and 235b are generated respectively therefrom. The intermediate frequency is a second intermediate frequency used by the low-intermediate frequency receiver 230. Then the mixed suppressed mirrored image signals 235a and 235b are added by an adder 238 and output of adding is passed to the demodulator 240 for demodulating.

It is noted that the synthesizer 260 provides the local oscillating signals used by the intermediate frequency receiver 210, as well as provides the local oscillating signals divided by dividers 232, 228A and 228B and being used by the zero-intermediate frequency receiver 220 and low-intermediate frequency receiver 230. For example, the local oscillating signal is divided by constant 4 and then used by the low-intermediate frequency receiver 230. The local oscillating signals are divided by constant 2 and then used by the zero-intermediate frequency receiver 220. But the dividing constants are not restricted to 2 or 4, and can be adjusted by the desire of circuit design.

Since the low-intermediate frequency receiver 210 uses a low frequency, the impedance match between the low-intermediate frequency receiver 210 and the zero-intermediate frequency receiver 220 will be easily made better than that made in the conventional architecture. Due to the improvement of impedance match, the whole performance of image reject receiver is significantly improved and getting better than before. Since it is operated in the low frequency, the local oscillating signals used by the zero-intermediate frequency receiver 220 and low-intermediate frequency receiver 230 will be easily produced by the synthesizer 260. The preferred embodiment is dividing the local oscillating signals generated by the synthesizer 260 with a constant, by which complex circuits required under operating at a high frequency are not necessary.

Furthermore, since the suppression of image is processed in the zero-intermediate frequency receiver 220, the number of filters used in the low-intermediate frequency receiver 210 and performance of operating thereof are less co-relation to the ratio of image signal frequency (or so called the radiation frequency) and the intermediate frequency. Under such condition, the number of filters used in the low-intermediate frequency receiver 210 can be reduced than the conventional architecture.

From the above description, some advantages of the invention are described as followed.

The present invention can reduce the chance of the re-radiation generated by the local oscillating signals being entered to the antenna, as well as apply simple dividing circuits instead of using complex circuits operating at a high frequency in prior art. In addition, since the improvement of the impedance match, the performance of operating frequency is much better and the number of filters using can be reduced and the limit of quality can be reduced in a large scale.

The present invention has been disclosed using an exemplary preferred embodiment. However, it is to be understood that the scope and the sprit of the invention is not limited to the disclosed embodiments, on the contrary, it is intended to cover various modifications and similar arrangements, the scope of the claims, therefore, should be accorded the broadest interpretation so as to encompass all such modifications and similar arrangements.

What is claimed is:

1. An image reject receiver, using a multi-low-intermediate frequency and a zero-intermediate frequency, the image reject receiver comprising:
a first low-intermediate frequency receiver, for receiving an image signal and transferring the image signal into an mirrored image signal by using a first intermediate frequency as a carrier in the first low-intermediate frequency receiver;
a zero-intermediate frequency receiver, for receiving the mirrored image signal by using a zero-intermediate frequency as a carrier and suppressing the frequency of the mirrored image signal to zero; and
a second low-intermediate frequency receiver, for receiving the suppressed mirrored image signal outputted from the zero-intermediate frequency receiver and transferring the frequency of the suppressed mirrored image signal from zero to a second intermediate frequency.

2. An image reject receiver as described in the claim 1, wherein the zero-intermediate frequency receiver further includes a DC calibration circuit for eliminating DC offsets generated from the zero-intermediate frequency receiver.

3. An image reject receiver as described in the claim 1, further includes a demodulator, for receiving and demodulating the suppressed mirrored image signal.

4. An image reject receiver as described in the claim 1, further includes a synthesizer for providing a local oscillating signal used in the first low-intermediate frequency receiver.

5. An image reject receiver as described in the claim 4, wherein the local oscillating signal generated by the synthesizer is divided by a constant and then is used by the zero-intermediate frequency and second low-intermediate frequency receiver.

6. An image reject receiver, comprising:
a first low-intermediate frequency receiver, for receiving an image signal and transferring the image signals into a mirrored image signal by using a first intermediate frequency as a carrier;
a zero-intermediate frequency receiver, including a DC calibration circuit, for receiving the mirrored image signal with the first intermediate frequency and transferring the mirrored image signal into a suppressed mirrored image signal, wherein the DC calibration circuit is used for eliminating DC offsets generated by the zero-intermediate frequency receiver.
a second low-intermediate frequency receiver, for receiving the suppressed mirrored image signal and transferring the suppressed mirrored image signal into a signal with a second intermediate frequency used in the second low-intermediate frequency receiver; and
a synthesizer, for providing a local oscillating signal used in the first low-intermediate frequency receiver.

7. The image reject receiver as described in the claim 6, further includes a demodulator, for receiving and demodulating the signal with the second intermediate frequency.

8. The image reject receiver as described in the claim 7, wherein the frequency of local oscillating signal is generated by synthesizer is divided by a constant and is used in the zero-intermediate frequency receiver.

9. An image reject receiver, which comprising:
a first intermediate frequency receiver, for receiving an image signal and transferring the image signal into an mirrored image signal by using a first intermediate frequency as a carrier;
a zero-intermediate frequency receiver, for receiving the mirrored image signal by using a zero-intermediate frequency as a carrier and suppressing the frequency of the mirrored image signal to zero; and
a second intermediate frequency receiver, for receiving the suppressed mirrored image signal and transferring the frequency of the suppressed mirrored image signal from zero to a second intermediate frequency.

10. An image reject receiver as described in the claim 9, wherein the zero-intermediate frequency receiver further includes a DC calibration circuit for eliminating DC offsets generated from the zero-intermediate frequency receiver.

11. An image reject receiver as described in the claim 9, further includes a demodulator, for receiving and demodulating the suppressed mirrored image signal.

12. An image reject receiver as described in the claim 9, further includes a synthesizer for providing a local oscillating signal used in the first intermediate frequency receiver.

13. An image reject receiver as described in the claim 12, wherein the local oscillating signal generated by the synthesizer is divided by a constant and then is used by the zero-intermediate frequency and second intermediate frequency receiver.
